(19) United States
(12) Patent Application Publication
(10) Pub. No.: US 2005/0254682 A1
(43) Pub. Date: Nov. 17, 2005

(54) Damper for speaker device, speaker device using the damper and manufacturing method therefor

(75) Inventors: Koji Maekawa, Tendo-shi (JP); Toshihiro Ishigaki, Tendo-shi (JP)

Correspondence Address: NIXON & VANDERHYE, PC, 901 NORTH GLEBE ROAD, 11TH FLOOR, ARLINGTON, VA, 22203, US

(73) Assignees: PIONEER CORPORATION, Tokyo (JP); TOHOKU PIONEER CORPORATION, Yamagata (JP)

(21) Appl. No.: 11/126,405

(22) Filed: May 11, 2005

(30) Foreign Application Priority Data
May 14, 2004 (JP) 2004-144577

(51) Int. Cl. H04R 25/00

(52) U.S. Cl. 381/404

(57) ABSTRACT

A damper having an annular elastic part is manufactured by stamping out a wire mesh material formed by weaving a plurality of metal wires into a net shape with a press device. The elastic part of the damper thus manufactured has a wire mesh structure. Thereby, a damper with high durability is obtained. Consequently, by applying this damper to the speaker device, the voice coil bobbin, a diaphragm and the like can be restrained/prevented from vibrating more than necessary even when an abnormal large signal is inputted into the speaker device.

### BACKGROUND OF THE INVENTION

1. Field of the Invention

The present invention relates to a structure of a damper in a speaker device.

2. Description of the Related Art

Recently, reflecting the demand of listeners to enjoy music and the like with powerful deep bass sound, increasingly larger signals tend to be inputted into a large-sized low sound reproducing speaker (for example, a subwoofer). Therefore, durability of a damper becomes a problem.

Thus, in such a large-sized speaker for reproducing low sound, a plurality of dampers are provided, or a damper made of aramido (aromatic polyamide) fiber with high durability is provided, or a damper or the like made by bonding a plurality of sheets of aramido fiber is provided in order to restrain a voice coil bobbin, a diaphragm and the like from vibrating more than necessary when an abnormally large signal is inputted.

However, when a plurality of dampers are provided, the size in the width direction of the speaker inevitably becomes large, thus causing the problem of increasing an outer dimension of the speaker.

In the damper made of the above described aramido fiber, a resin material is used as a hardening agent to enhance its rigidity. Therefore, in the speaker having such a damper, there is the problem that when a force is partially applied to the damper, the part to which the force is applied deteriorates in durability and becomes easily bent, and is ultimately cut. Thus, the damper is sometimes reinforced by bonding two sheets of aramido fiber to the damper, but in this case, there arises the problem of increasing the cost.

There is known a damper for a speaker in which an inner peripheral waveform part and an outer peripheral waveform part are provided, and a flat part is provided therebetween in order to suppress a rolling phenomenon and the like of a voice coil bobbin and a diaphragm (for example, see Patent Japanese Patent Application Laid-Open under No. 2003-199192). There is also known a hardening resin composition suitable for assembly of a speaker using a damper made of aramido fiber (for example, see Japanese Patent Application Laid-Open under No. 2000-159835). There is also known a speaker damper having a sheet metal which functions as a plate spring (for example, see Japanese Patent Application Laid-Open under No. 11-225396).

### SUMMARY OF THE INVENTION

As the problems to be solved by the present invention, those described above are cited as examples. An object of the present invention is to provide a damper for a speaker device capable of restraining a voice coil bobbin and the like from vibrating more than necessary when an abnormal large signal is inputted, a speaker device using the damper and a manufacturing method therefor.

According to one aspect of the present invention, there is provided a damper for a speaker device including an elastic part made by weaving a plurality of metal wires into a net shape.

The above described damper for a speaker device includes an elastic part having a wire mesh structure formed by weaving a plurality of metal wires into a net shape, and therefore rigidity (strength) of the damper can be enhanced. Therefore, by applying the damper to the speaker device, the vibrating system can be reliably supported even when the vibrating system such as a diaphragm makes large movement. Namely, when an abnormal large signal is inputted to the speaker device, the voice coil bobbin, the diaphragm and the like can be restrained/prevented from vibrating (amplifying) more than necessary. It is not necessary to provide a plurality of dampers at the speaker device. Thereby, the outer dimension of the speaker device can be prevented from being large, and the cost of the speaker device can be lowered.

The elastic part may be formed into a net shape, and the damper has elasticity to some degree. Therefore, the respective metal wires can be displaced in accordance with the magnitude of the vibration of the diaphragm and the like at the time of driving the speaker device. As a result, even when a force partially acts on the damper at the time of driving the speaker device, the respective metal wires of the elastic part respectively displace in constant directions to scatter such a force, and therefore partial bending or cut can be prevented from occurring to the elastic part.

In the case where the damper made of a cloth material or the like coated with a hardening agent or the like is applied to the phase inversion type speaker device, when a large signal is inputted into the speaker device, the diaphragm vibrates significantly though low sound is not reproduced at the lowest resonance frequency fo of the bus ref port or less. As a result, the damper and edge made of such a material cannot keep enough strength to support the diaphragm, and they are sometimes bent partially, or cut and broken. On the contrary, if this damper is applied to the phase inversion type speaker device, such a problem does not occur. This is because the elastic part of this damper is formed into a net shape by using the metal material with high rigidity as a component material.

Since the elastic part is formed into a net shape, the small recessed and projected shape, namely, the corrugated shape is naturally formed at the elastic part. Therefore, according to this damper, necessary compliance (softness of the damper) to support the vibration system can be obtained.

Since the elastic part is formed into the net shape, the respective metal wires rub against each other at the time of driving the speaker device, and unnecessary resonance of the diaphragm and the like can be restrained by the friction resistance.

By applying this damper to the speaker device, air permeability in the speaker device is ensured and vertical movement of the diaphragm or the like is smoothly performed. Therefore, an adverse effect can be prevented from being given to the acoustic characteristic and the like. Since the entire surface of the elastic part is not covered with a metal plate, resonance hardly occurs, and an adverse effect can be prevented from being given to the acoustic characteristic and the like.

In one mode of the above described damper for a speaker device, the elastic part is formed into a recessed and projected shape by being pressed by a press device. Namely, the small recessed and projected shape is formed in the elastic part of this damper as described above. According to this mode, the recessed and projected shape of a desired size, namely, the corrugated shape can be formed in the elastic part by the press device. As a result, compliance can be made large.

In another mode of the above described damper for a speaker device, the elastic part is formed into an annular shape by being stamped out by a press device. This makes it possible to mount this damper to an ordinary speaker device. Namely, it becomes possible to mount the inner peripheral edge part of the elastic part to the voice coil bobbin in the substantially cylindrical shape, and it becomes possible to mount the outer peripheral edge portion of the elastic part to the frame.

In still another mode of the above described damper for a speaker device, resin molding work is performed and a resin body is mounted onto at least one of an inner peripheral edge portion and an outer peripheral edge portion of the elastic part. In a preferable example, the resin body mounted to the outer peripheral edge portion may be formed into a ring shape. The resin body mounted to the inner peripheral edge portion may have a cylinder body formed into a substantially cylindrical shape. Thereby, the outer peripheral edge portion of the elastic part can be easily mounted on the frame via the resin body, and the inner peripheral edge portion of the elastic part can be easily mounted to the voice coil bobbin which is formed into a substantially cylindrical shape via the resin body. If the cylinder body of the resin body which is mounted to the inner peripheral edge portion is formed to be longer, the inner peripheral edge portion of the diaphragm can be also mounted to the outer peripheral wall of the cylinder body.

In still another mode of the above described damper for a speaker device, intersecting portions of the metal wires of the elastic portion may be coated with an elastic material.

According to this mode, the intersecting portions of the metal wires of the elastic part are coated with an elastic material such as resin and rubber, and therefore the metal wires are connected to each other in the elastic state. More specifically, only the intersecting portions of the metal wires of the elastic part may be coated with the elastic material, or the entire elastic part may be coated with the elastic material. Thereby, mechanical resistance is given to the elastic part, and therefore the movement of the damper in the vertical direction is restrained to some extent. As a result, sharpness of resonance, so-called Q (Quality factor) can be lowered, and the vibration at high frequency can be restrained. By coating the entire elastic part with the elastic material, the damper can be made resistant to rust.

In still another mode of the above described damper for a speaker device, each of the plurality of metal wires is coated with an elastic material. This makes the damper resistant to rust.

In still another mode of the above described damper for a speaker device, intersecting portions of the metal wires coated with the elastic material are connected to each other.

According to this mode, the metal wires are connected to each other in the elastic state to some extent by applying heat or ultrasonic waves to the elastic part. As a result, the elastic part is in the state in which the mechanical resistance is added, and therefore, the movement of the damper in the vertical direction is restrained to some extent. Thereby, sharpness of resonance, so-called Q can be lowered, and vibration at high frequency can be restrained.

The speaker device including the above described speaker device can be constructed.

In one mode of the above described speaker device, one end of a part of the metal wires constructing the elastic part of the damper for the speaker device is electrically connected to a voice coil, and the other end of the part of the metal wires is electrically connected to a relay wiring at an amplifier side via a terminal member.

According to this mode, one end of the part of the metal wires constructing the elastic part is electrically connected to the lead wire which is lead out of the voice coil. Meanwhile, the other end of the part of the metal wires is electrically connected to the relay wiring at the side of the amplifier via the terminal member. Therefore, the part of the metal wires of this damper can be used as the lead wire of the voice coil, and the voice coil and the side of the amplifier can be electrically connected. Namely, it is possible to use this damper as the conductive damper.

According to another aspect of the invention, there is provided a manufacturing method of a speaker device including a damper manufacturing step having the steps of forming a wire mesh material by weaving a plurality of metal wires into a net shape, and manufacturing a damper for a speaker device having an annular elastic part by stamping out the formed wire mesh material with a press device.

According to the above described manufacturing method of the speaker device, the damper for the speaker device having the annular elastic part can be manufactured by stamping out the wire mesh material formed by weaving a plurality of metal wires into the net shape with the press device. As the material of the metal wires, materials such as stainless steel, beryllium copper, phosphor bronze, and bronze are preferable. By using such a material for each of the metal wires, rust resistant effect can be obtained. In the damper for the speaker device thus manufactured, the elastic part has the wire mesh structure. Therefore, by applying the damper to the speaker device, the voice coil bobbin, the diaphragm and the like can be restrained/prevented from vibrating more than necessary even when an abnormal large signal is inputted into the speaker device.

The elastic part has the net shape, and the respective metal wires can be displaced in accordance with the magnitude of the vibration of the diaphragm and the like at the time of driving the speaker device. Thereby, even when the force is partially applied to the damper at the time of driving the speaker device, the respective metal wires of the elastic part displace in the constant directions to scatter such a force, and therefore partial bending or cut can be prevented from occurring to the elastic part.

According to one mode of the above described manufacturing method of the speaker device, the damper manufacturing step includes the step of forming the elastic part into a recessed and projected shape. Thereby, the recessed and projected shape of the desired size, namely, the corrugated shape can be formed in the elastic part. Thereby, compliance can be made large.

In another mode, the above described manufacturing method of the speaker device includes a resin molding step for forming a resin body to at least one of an inner peripheral edge portion and an outer peripheral edge portion of the elastic part of the damper for the speaker device manufactured in the damper manufacturing step.

According to this mode, in the resin molding step, for example, in the work step by insert molding, the resin body can be mounted to at least one of the inner peripheral edge portion and the outer peripheral edge portion of the elastic part. In the preferable example, the resin body mounted to the outer peripheral edge portion of the elastic part can be formed into a ring shape. Thereby, the outer peripheral edge portion of the elastic part can be easily mounted on the frame via the resin body. The resin body mounted to the inner peripheral edge portion of the elastic part has the cylinder body formed into the substantially cylindrical shape. Thereby, the inner peripheral edge portion of the elastic part can be easily mounted to the voice coil bobbin formed into the substantially cylindrical shape via the resin body.

In still another mode, the above described manufacturing method of the speaker device includes a coating step for coating intersecting portions of the metal wires of the elastic part with an elastic material. More specifically, only the intersecting portions of the metal wires of the elastic part may be coated with the elastic material, or the entire elastic part may be coated with the elastic material.

According to this mode, in the coating step, the intersecting portions of the metal wires of the elastic part can be coated with the elastic material such as resin and rubber. Thereby, the respective metal wires are connected to each other in the elastic state. As a result, the elastic part is in the state in which it is given the mechanical resistance, and therefore, the movement of the damper in the vertical direction is restrained to some extent. Thereby, sharpness of resonance, so-called Q can be lowered, and the vibration at high frequency can be restrained. By coating the entire elastic part with the elastic material, the damper can be made resistant to rust.

As a preferable resin material, a phenol resin, an epoxy resin and the like are cited. As a preferable rubber material, natural rubber, synthetic rubber, thermoplastic elastomer, silicon rubber and the like are cited. These resin materials and rubber materials may be solely used, or mixture of several kinds of them may be used, or may be used by being coated in several layers. As a coating method, various kinds of methods such as, powder coating, static coating, brush coating, spraying, and impregnation can be applied, for example.

In still another mode, the above described manufacturing method of a speaker device includes the step of connecting the intersecting portions of the metal wires coated with the elastic material to each other by adding heat or emitting ultrasonic wave to the elastic part.

According to this mode, in such step, by applying heat or ultrasonic wave to the elastic part, the respective metal wires can be connected to each other in the elastic state to some extent. The elastic part is in the state in which the mechanical resistance is given, and therefore the movement of the damper in the vertical direction is restrained to some extent. Thereby, sharpness of resonance, so-called Q can be lowered, and the vibration at high frequency can be restrained.

In still another mode, the above described manufacturing method of a speaker device includes the step of electrically connecting one end side of a part of the metal wires coated with the elastic material and a voice coil, and electrically connecting the other end side of the metal wire and a relay wiring at a side of an amplifier via a terminal member.

According to this mode, in such a step, the one end side of the part of the metal wires coated with the elastic material and the voice coil can be electrically connected. In such a step, the other end side of the metal wire and the relay wiring at the side of the amplifier can be electrically connected via the terminal member. Thereby, the voice coil and the amplifier side can be electrically connected via the damper, and it is possible to use the damper as the conductive damper.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is plane view of a damper according to a first embodiment of the present invention;

FIGS. 2A and 2B are a sectional view of a damper and a partially enlarged plane view of an elastic part according to the first embodiment;

FIG. 3 is a sectional view of a damper according to a second embodiment of the present invention;

FIG. 4 is a plane view of a damper according to a third embodiment of the present invention;

FIG. 5 is a sectional view of the damper according to the third embodiment;

FIGS. 6A, 6B and 6C show the respective sectional views of dampers according to a fourth to sixth embodiments;

FIGS. 7A and 7B show examples in which the dampers according to the first and second embodiments are applied to the speaker device;

FIGS. 8A and 8B show examples in which the dampers according to the third and fourth embodiments are applied to the speaker device;

FIGS. 9A and 9B show examples in which the dampers according to the fifth and sixth embodiments are applied to the speaker device;

FIG. 10 shows a flow chart of a manufacturing method of a speaker device having the damper according to each of the embodiments of the present invention; and

FIG. 11 shows a manufacturing process of the damper of the present invention.

### DETAILED DESCRIPTION OF THE PREFERRED EMBODIMENTS

A preferred embodiment of the present invention will be explained with reference to the drawings hereinafter. In order to effectively restrain a voice coil bobbin, a diaphragm and the like from vibrating (amplifying) more than necessary when an abnormal large signal is inputted into a speaker device, the present invention especially provides a damper with high durability made by knitting metal wires with high rigidity into a net shape. Thus, various kinds of embodiments of the damper, constructions of the speaker devices having the dampers of various kinds of embodiments, and manufacturing methods of the speakers will be explained hereinafter. The damper of the present invention is preferably applied to on-vehicle speaker devices.

### Construction of Damper (1st Embodiment)

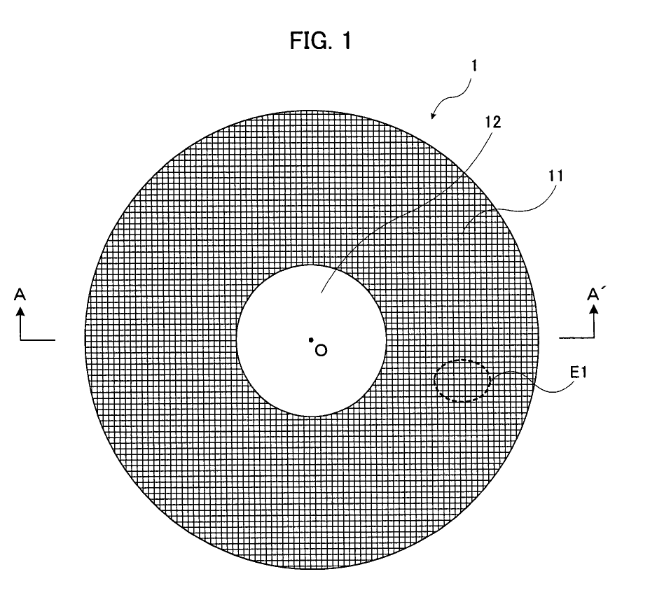

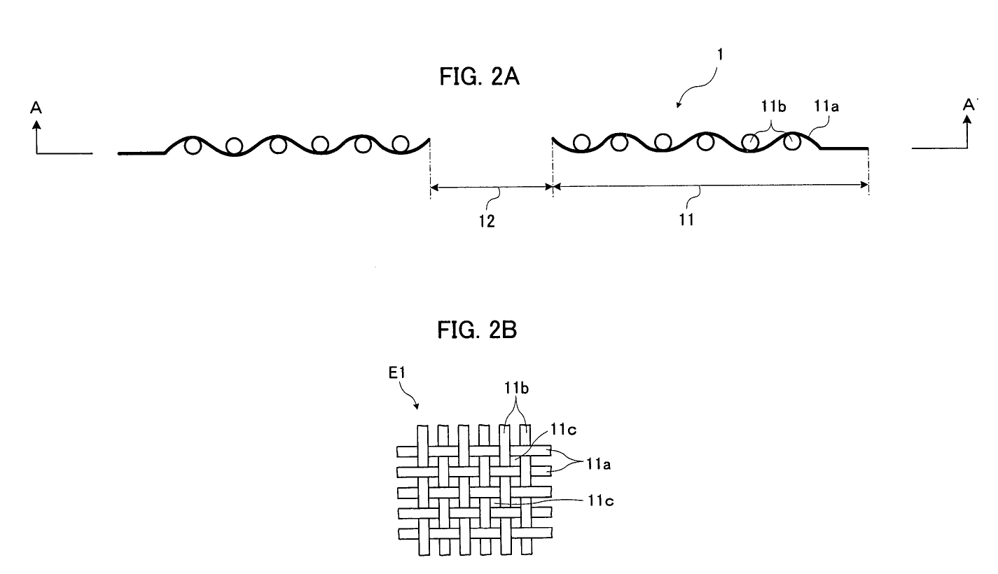

A damper 1 according to a first embodiment is made by pressing a material made by weaving metal wires into a net shape into an annular shape by a press device or the like. Referring to FIGS. 1 and 2A and 2B, a construction of the damper 1 according to the first embodiment will be explained. FIG. 1 shows a plan view of the damper 1. FIG. 2A is a sectional view taken along a cut line A-A′ in FIG. 1. FIG. 2B is a plane view of an enlarged part of a broken line area E1 of the damper 1 in FIG. 1.

The damper 1 is formed into an annular shape and has an elastic part 11 and an opening 12. A voice coil bobbin in a substantially cylindrical shape is inserted into the opening 12 formed into a circular shape. The elastic part 11 has a wire mesh structure in which a plurality of metal wires 11a extending substantially parallel with each other and a plurality of metal wires 11b extending in a substantially perpendicular direction to them are woven alternately as shown in FIGS. 2A and 2B. Therefore, the elastic part 11 is formed into a small recessed and projected shape, namely, a corrugated shape as shown in FIG. 2A. Each of the metal wires 11a and each of the metal wires 11b are not fixed. An air hole 11c is formed in a part surrounded by the respective metal wires 11a and the respective metal wires 11b. It is possible to use materials having various kinds of sectional shapes such as a circular shape and a rectangular shape for the metal wires 11a and 11b as necessary. As the materials for the metal wires 11a and 11b, materials such as stainless steel, beryllium copper, phosphor bronze and bronze are preferable. Rust prevention effect can be obtained by using such materials for the respective metal wires 11a and 11b. As will be described later, an outer peripheral edge portion of the elastic part 11 is attached to a frame of the speaker device, and an inner peripheral edge portion of the elastic part 11 is attached to the voice coil bobbin. Thereby, the damper 1 has the function of supporting the voice coil bobbin, the diaphragm and the like movably in the axial direction of the speaker device.

Since metal is used as a component material of the elastic part 11, and the elastic part 11 is formed into a net-shaped structure, the damper 1 with durability can be obtained. Thus, it is not necessary to use a plurality of dampers for a large-sized speaker device (for example, subwoofer) for reproducing low sound. Thereby, the outer dimension of the speaker device can be prevented from becoming large and the cost of the speaker device can be reduced.

Since the respective metal wires 11a and 11b are not fixed to each other, the damper 1 has the elasticity to some extent. This enables the respective metal wires 11a and 11b to displace in accordance with the magnitude of the vibration of the diaphragm and the like at the time of driving the speaker device. Thus, even when a force is partially applied to the damper 1 at the time of driving the speaker device, the respective metal wires 11a and 11b of the elastic part 11 respectively displace in constant directions to scatter such a force, and therefore, partial bending or cut can be prevented from occurring to the elastic part 11.

According to such a structure of the damper 1, even when an abnormal large signal is inputted into the speaker device, the voice coil bobbin, the diaphragm and the like can be restrained/prevented from vibrating (amplifying) more than necessary. As shown in FIG. 2B, the elastic part 1 has the net-shaped structure, and therefore a small recessed and projected shape, namely a corrugated shape is formed at the elastic part 11. Hence, a necessary compliance (softness of the damper) to support a vibration system such as the diaphragm can be obtained.

As a comparative example to this embodiment, when a known damper made of a cloth material or the like which is coated with a hardening agent or the like is applied to a phase inversion type (also known as “bass-reflex type”) speaker device, the following disadvantage occurs. Namely, when a large signal is inputted into such a speaker device, the diaphragm vibrates (amplifies) significantly though low sound is not reproduced at the lowest resonance frequency f₀ or lower of the bass reflex port. As a result, the damper and edge which are made of such a material cannot keep enough strength to support the diaphragm, and are sometimes bent partially or cut and ultimately broken.

On the contrary, when the damper 1 according to the first embodiment is applied to the phase inversion type speaker device, such a disadvantage does not occur. This is because the metal material with high rigidity is used for the component material of the elastic part 11 of the damper 1, and the elastic part 11 is formed into the net shape.

As a comparative example to this embodiment, when a damper of which entire surface is covered with a metal plate is mounted to an external magnet type speaker device, for example, a space between the damper and a magnetic circuit disposed at its lower side is closed by them. Therefore, when the damper, the diaphragm, the voice coil bobbin and the like move to the lower side, they need to compress air between the damper and the magnetic circuit. Therefore, the diaphragm and the like are inhibited from moving to the lower side by air resistance at the time of compression, and there is the fear of having an adverse effect on the acoustic characteristics and the like. Since the entire surface of the damper is covered with the metal plate, resonance easily occurs, and therefore there is the fear of having an adverse effect on the acoustic characteristics.

On the contrary, when the damper 1 according to the first embodiment is applied to the speaker device, a space located at the upper side of the damper 1 and a space located at a lower side of the damper 1 communicate with each other via the air holes 11c of the elastic part 11. As a result, air permeability is ensured, and vertical movement of the diaphragm and the like is smoothly performed when the speaker device is driven. Thus, an adverse effect is prevented from being given to the acoustic characteristics. Also, the damper 1 according to the first embodiment has the net-shaped structure without having the entire surface covered with the metal plate, and therefore resonance hardly occurs in terms of the structure.

Since the damper 1 according to the first embodiment has the net-shaped structure, the respective metal wires 11a and the respective metal wires 11b rub against each other at the time of driving the speaker device, and unnecessary resonance of the diaphragm and the like can be restrained by the friction resistance.

### Construction of Damper (2nd Embodiment)

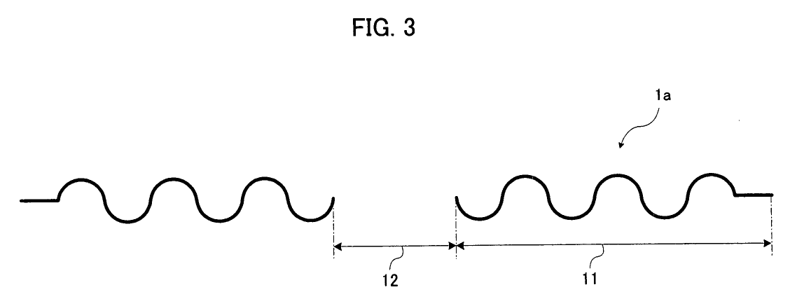

The elastic part 11 of the damper 1 according to the first embodiment has a small corrugated shape as shown in the sectional view in FIG. 2A. As described above, this is formed by weaving the respective metal wires 11a and the respective metal wires 11b. On the contrary, a damper 1a according to a second embodiment has a larger recessed and projected shape, namely, corrugated shape as compared with the elastic part 11 of the first embodiment. This is because the elastic part 11 having a small corrugated shape is pressed into a recessed and projected shape of a desired size by the press device. Such a recessed and projected shape is formed at the same time when the damper 1a is produced. Here, FIG. 3 shows a sectional view of the damper 1a according to the second embodiment thus formed. In FIG. 3, the same components as the damper 1 according to the first embodiment are given the same reference numerals and characters and the explanation thereof will be omitted. Though the illustration of the metal wire 11b extending in the perpendicular direction to the paper surface is omitted for convenience of illustration, the metal wires 11b actually extend in the substantially perpendicular direction to the metal wires 11a as in the first embodiment shown in FIGS. 2A and 2B. In the damper 1a according to the second embodiment, the corrugated shape of the elastic part 11 is formed to be large to some extent, and therefore compliance can be made larger as compared with the damper 1 according to the first embodiment. The other operation and effect of the damper 1a according to the second embodiment are the same as the damper 1 according to the first embodiment, and therefore the explanation will be omitted.

### Construction of Damper (3rd Embodiment)

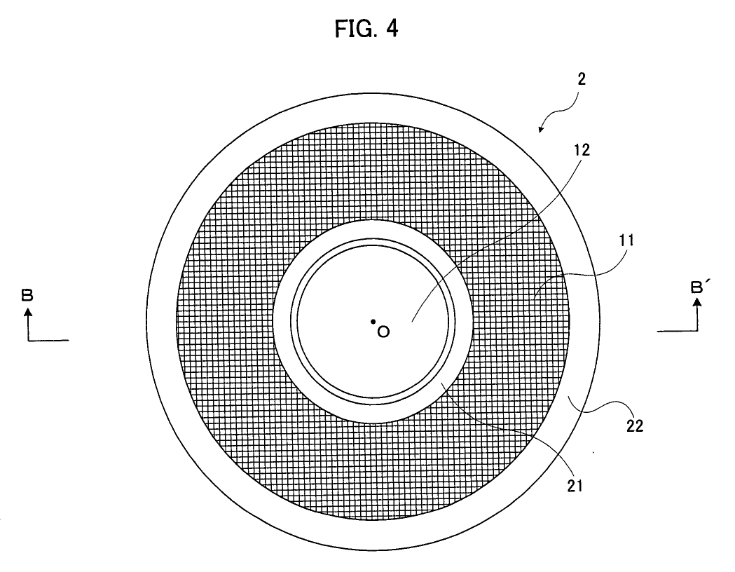

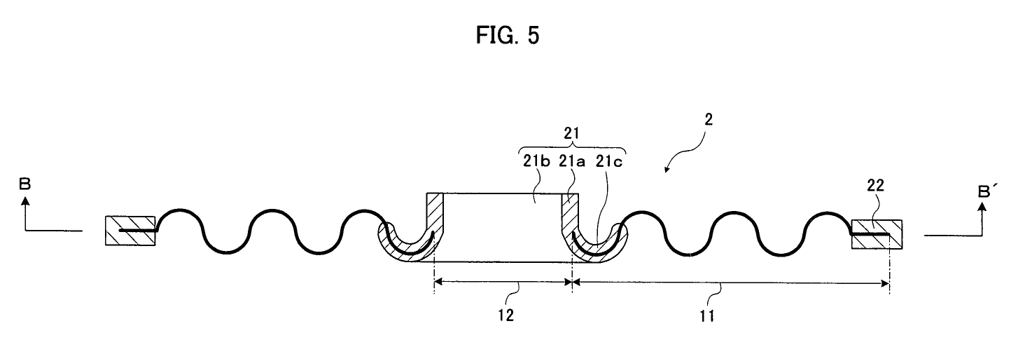

A damper 2 according to the third embodiment is made by the resin molding work (insert molding work) for the inner peripheral edge portion and the outer peripheral edge portion of the damper 1a according to the second embodiment. Referring to FIGS. 4 and 5, a construction of the damper 2 according to the third embodiment will be explained. FIG. 4 shows a plane view of the damper 2. FIG. 5 shows a sectional view taken along the cut line B-B′ in FIG. 4. In FIGS. 4 and 5, the same components as the damper 1 according to the first embodiment are given the same reference numerals and characters, and the explanation thereof will be omitted. Though illustration of the metal wires 11b extending in the perpendicular direction to the paper surface is omitted for convenience of illustration, the metal wires 11b actually extend in the substantially perpendicular direction to the metal wires 11a as in the first embodiment shown in FIGS. 2A and 2B.

The damper 2 has resin bodies 21 and 22 in addition to the above described elastic part 11 and opening 12. The resin body 21 is formed at the inner peripheral edge portion of the elastic part 11 and the resin body 22 is formed at the outer peripheral edge portion of the elastic part 11. Namely, the resin molding work is applied to the inner peripheral edge portion of the elastic part 11 by a molding machine (not shown), and the resin body 21 is attached. Meanwhile, resin molding work is applied to the outer peripheral edge portion of the elastic part 11 by a molding machine and the resin body 22 is attached.

The resin body 21 is the member for connecting the inner peripheral edge portion of the damper 2 and the voice coil bobbin. As shown in FIG. 5, the resin body 21 has a substantially columnar through-hole 21b, a substantially cylindrical cylinder body 21a, and an insertion part 21c formed into a shape of a fishhook in the sectional state. The voice coil bobbin formed into a substantially cylindrical shape is inserted into the through-hole 21b. In the state in which the damper 2 is mounted to the voice coil bobbin, the inner peripheral wall of the cylinder body 21a contacts the outer peripheral wall of the voice coil bobbin. The inner peripheral edge portion of the elastic part 11 is integrated with the insertion part 21c of the resin body 21 by insert molding. Namely, the insertion part 21c fixes the inner peripheral edge portion of the elastic part 11.

The resin body 22 is a member for connecting the outer peripheral edge portion of the damper 2 and the frame. The resin body 22 is formed into a ring shape. The outer peripheral edge portion of the elastic part 11 is integrated with the resin body 22 by insert molding. Namely, the resin body 22 fixes the outer peripheral edge portion of the elastic part 11.

As described above, according to the damper 2 according to the third embodiment, resin molding work is applied to the inner peripheral edge portion and the outer peripheral edge portion of the elastic part 11, and therefore it becomes possible to easily mount the damper 2 having the wire mesh structure to the voice coil bobbin and the frame via the resin bodies 21 and 22. The other operation and effect of the damper 2 according to the third embodiment are the same as the damper 1 according to the first embodiment, and the explanation thereof will be omitted.

### Construction of Damper (4th Embodiment)

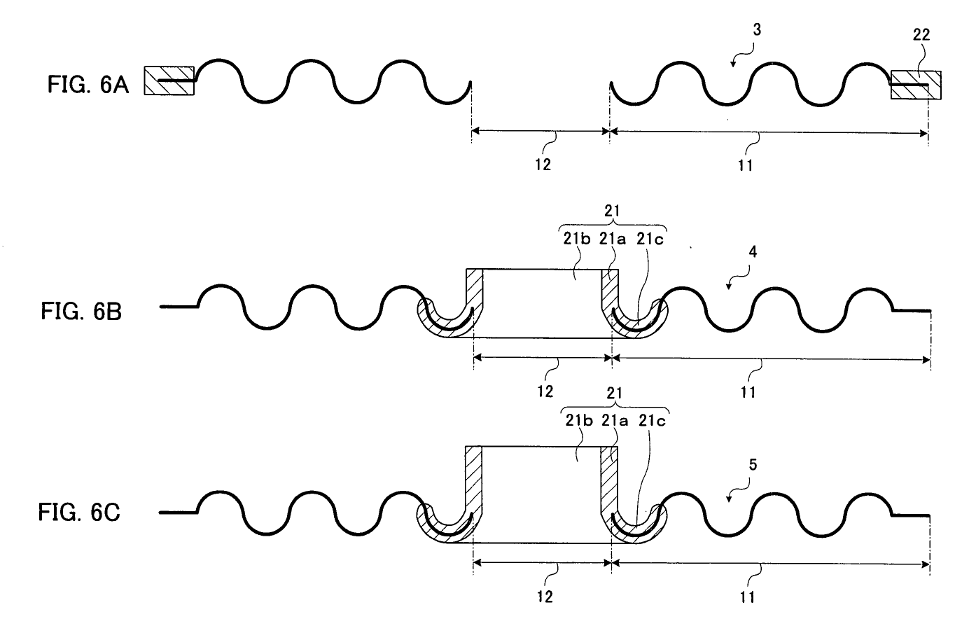

FIG. 6A shows a sectional view of a damper 3 according to a fourth embodiment. When comparing the damper 2 according to the third embodiment and the damper 3 according to the fourth embodiment, the latter has the resin molding work applied only to the outer peripheral edge portion of the elastic part 11 unlike the former. Namely, in the damper 3 according to the fourth embodiment, the resin body 22 is formed at the outer peripheral edge portion of the elastic part 11. In the present invention, it is possible to form the resin body 22 only at the outer peripheral edge portion of the elastic part 11 in accordance with the kind of the speaker device as described above. The other operation and effect of the damper 3 according to the fourth embodiment are the same as the damper 1 according to the first embodiment and the explanation of them will be omitted. Though the illustration of the metal wires 11b extending in the perpendicular direction to the paper surface is omitted for convenience of illustration, the metal wires 11b actually extend in the substantially perpendicular direction to the metal wires 11a as in the first embodiment shown in FIGS. 2A and 2B.

### Construction of Damper (5th Embodiment)

FIG. 6B shows a sectional view of a damper 4 according to a fifth embodiment. Comparing the damper 2 according to the third embodiment and the damper 4 according to the fifth embodiment, the latter has the resin molding work applied only to the inner peripheral edge portion of the elastic part 11 unlike the former. Namely, in the damper 4 according to the fifth embodiment, the resin body 21 is formed at the inner peripheral edge portion of the elastic part 11. In the present invention, it is possible to form the resin body 21 only at the inner peripheral edge portion of the elastic part 11 in accordance with the form of the speaker device as described above. The other operation and effect of the damper 4 according to the fifth embodiment are the same as the damper 1 according to the first embodiment and the explanation will be omitted. Though the metal wires 11b extending in the perpendicular direction to the paper surface is omitted for convenience of illustration, the metal wires 11b actually extend in the substantially perpendicular direction to the metal wires 11a as in the first embodiment shown in FIGS. 2A and 2B.

### Construction of Damper (6th Embodiment)

FIG. 6C shows a sectional view of a damper 5 according to a sixth embodiment. As understood by comparing the damper 4 according to the fifth embodiment and the damper 5 according to the sixth embodiment, the latter and the former are the same in the respect that they both have the resin bodies 21 at the inner peripheral edge portion of the elastic part 21, but they differ in the respect that the length of the cylinder part 21a of the resin body 21 of the latter is formed to be longer than that of the former. This is because the inner peripheral edge portion of the diaphragm is sometimes attached to the upper end portion of the outer peripheral wall of the resin body 21 depending on the kind of the speaker device. The other operation and effect of the damper 5 according to the sixth embodiment are the same as the damper 1 according to the first embodiment and the explanation thereof will be omitted. Though the illustration of the metal wires 11b extending in the perpendicular direction to the paper surface is omitted for convenience of illustration, the metal wires 11b actually extend in the substantially perpendicular direction to the metal wires 11a as in the first embodiment shown in FIGS. 2A and 2B.

In the above described dampers according to the first embodiment to the sixth embodiment, no work is applied to the respective metal wires 11a and 11b of the elastic part 11. However, it is possible to perform coating for the intersecting portions of the respective metal wires 11a and metal wires 11b or the entire surface of the elastic part 11 with an elastic material such as a resin and rubber after the dampers according to the first embodiment to the sixth embodiment are produced.

Namely, by coating the intersecting portions of the respective metal wires 11a and metal wires 11b with the elastic material such as a resin and rubber, the respective metal wires 11a and the respective metal wares 11b are connected in the elastic state. Thereby, the elastic part 11 is in the state given the mechanical resistance, and therefore the movement of the damper in the vertical direction is restrained to some extent. Thus, as compared with the damper in which the respective metal wires 11a and 11b are not connected, sharpness of resonance, so-called Q can be reduced, and vibration at high frequency can be suppressed. At this time, by properly changing the elastic material with which the respective metal wires 11a and 11b are coated, the degree of damping of the diaphragm and the like can be adjusted. The damper can be made resistant to rust by coating the entire elastic part 11 with an elastic material.

As a favorable resin material for coating the respective metal wires, various kinds of resins and the like such as a phenol resin, an epoxy resin, polyester resins such as polyethylene terephthalate and polybutylene terephthalate, a polyamide resin such as nylon, a polyimide resin, an acryl resin, an urethane resin, a styrene resin, a melamine resin, a urea resin, a polypropylene resin, an ABS resin, a polycarbonate resin, a polyacetal resin, a modified polyphenylene ether resin, and a fluororesin are cited. As preferable rubber materials, natural rubber, synthetic rubber such as IIR, NBR and SBR, thermoplastic elastomer, silicon rubber and the like are cited. These resin materials and rubber materials may be solely used, or mixture of several kinds of them may be used, or they may be used by being coated in several layers. As a method for coating, various kinds of methods such as powder coating, electrostatic coating, brush coating, spraying and impregnation, for example can be applied.

In the damper according to the above described first to sixth embodiments, the elastic part 11 is formed by weaving the bare metal wires 11a and 11b in the net shape. However, the elastic part 11 is not limited to this, and the elastic part 11 may be formed by weaving the metal wires 11a and 11b previously coated with resin or the like respectively into the net shape in the dampers according to the above described first to sixth embodiments. Thereby, rust prevention effect of the elastic part 11 can be obtained. The strand at one end side of the metal wire 11a coated with a resin or the like is electrically connected to the lead wire of the voice coil, and the strand at its other end side is electrically connected to relay wiring at the amplifier side through the terminal member of the speaker device, whereby the elastic part 11 can be used by the lead wire of the voice coil. Namely, the dampers according to the above described first to sixth embodiments can be used as the conductive damper.

Further, in the above description, heat may be applied to or ultrasonic waves may be irradiated to the metal wires 11a and 11b previously coated with a resin or the like, so that the metal wire 11a coated with a resin or the like and the metal wire 11b coated with a resin or the like are connected. As a result, the respective metal wires 11a and the respective metal wires 11b are connected in the elastic state. Thereby, the elastic part 11 is given the mechanical resistance, and hence the movement in the vertical direction of the damper is restrained to some extent. Thus, as compared with the damper in which the respective metal wires 11a and 11b are not connected to each other, Q can be lowered and the vibration at high frequency can be restrained.

The dampers according to the above described third embodiment to sixth embodiment are predicated on the damper according to the above described second embodiment, but without being limited to this, the dampers according to the above described third embodiment to sixth embodiment may be predicated on the damper according to the above described first embodiment. In the damper of the present invention, various modifications can be made without departing from the spirit of the present invention.

[Application Example to Speaker Device]

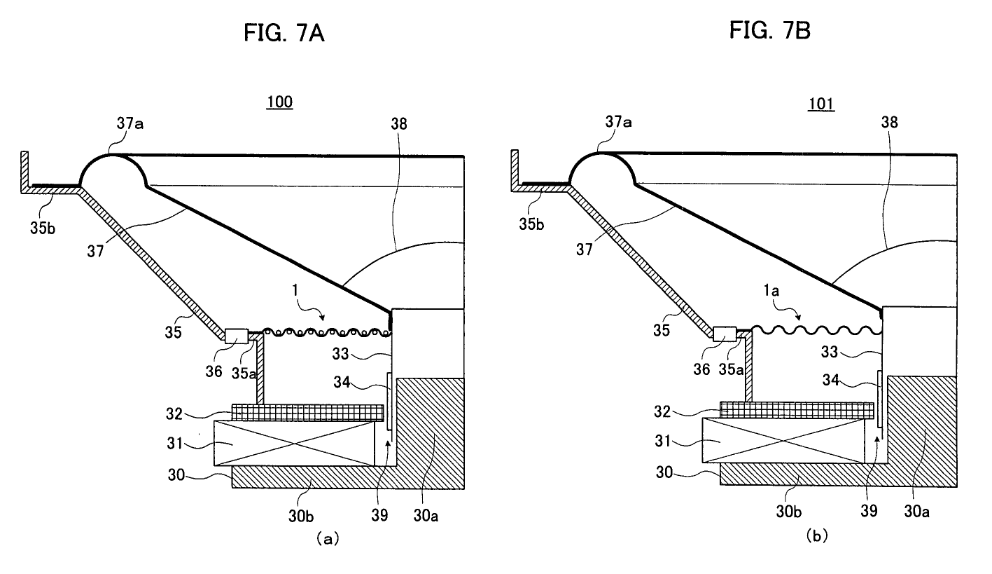

Next, referringto FIG. 7A to FIG. 9B, an example in which the dampers according to the above described first embodiment to sixth embodiment are applied to the external magnet type speaker device will be explained. FIG. 7A shows one example in which the damper 1 according to the first embodiment is applied to the speaker device. FIGS. 7 to 9 show only a one side sectional view of the speaker device.

(Construction of Speaker Device 100)

First, a construction of a speaker device 100 will be explained with reference to FIG. 7A. The speaker device 100 mainly includes a magnetic circuit system having a pole piece 30, a magnet 31 and a plate 32, a vibration system having a voice coil bobbin 33, a voice coil 34, a frame 35, the damper 1 according to the first embodiment and a diaphragm 37, and the other various kinds of members. The speaker device 100 is a speaker device for reproducing low bass sound, and is capable of emitting sound with an output at a high-volume level.

The magnetic circuit system will be explained. The pole piece 30 is formed into a substantially inversed T-shape in the sectional view, and has a center pole 30a formed into a substantially columnar shape and a yoke 30b formed into a substantially planar shape. The magnet 31 formed into an annular shape is disposed on the yoke 30b to overlay the yoke 30b, and the plate 32 formed into an annular shape is disposed on the magnet 31 to overlay the magnet 31. An outer peripheral wall of the center pole 30a opposes inner peripheral walls of the magnet 31 and the plate 32 respectively. In this magnetic circuit system, the magnetic circuit is constructed by the magnet 31 and the plate 32, and magnetic flux of the magnet 31 is concentrated on a magnetic gap 39 formed between an inner peripheral wall of the plate 32 and the outer peripheral wall of the center pole 30a.

Next, the vibration system will be explained. The voice coil bobbin 33 has an opening at an undersurface side, and is formed into a substantially cylindrical shape. A lower end portion of the outer peripheral wall of the voice coil bobbin 33 is opposed to the outer peripheral walls of the magnet 31 and the plate 32 at constant spaces away from them. Meanwhile, a lower end portion of an inner peripheral wall of the voice coil bobbin 33 is opposed to an outer peripheral wall of the center pole 30a at a constant space away from it.

A voice coil 34 is wound around a lower end portion of the outer peripheral wall of the voice coil bobbin 33. An electric signal of one channel is inputted into the voice coil 34 from the amplifier side.

The frame 35 is formed into substantially a cup shape, and has a flange part 35a formed at a center portion and a flange part 35b formed at an upper part. The frame 35 has a role of supporting each component of the vibration system or else. The lower end portion of the frame 35 is mounted on the plate 32.

The construction of the damper 1 according to the first embodiment is as described above. The inner peripheral edge portion of the damper 1 is mounted in the vicinity of the upper end of the outer peripheral wall of the voice coil bobbin 33. Meanwhile, the outer peripheral edge portion of the damper 1 is mounted on the flange part 35a of the frame 35.

The diaphragm 37 is a so-called conical diaphragm, and is formed integrally with an edge part 37a. Various kinds of materials such as paper, polymer, and metal can be applied to the diaphragm 37 in accordance with various kinds of use purposes. The outer peripheral edge portion of the diaphragm 37, namely, a lower end portion of the edge part 37a is fixed onto the flange part 35b of the frame 35. Meanwhile, the inner peripheral edge portion of the diaphragm 37 is fixed in the vicinity of the upper end of the outer peripheral wall of the voice coil bobbin 33.

The speaker device 100 further includes members such as a dust protective cap 38 and a terminal member 36. The dust protective cap 38 is disposed above the voice coil bobbin 33. The dust protective cap 38 has the function of preventing a foreign matter such as powder dust from entering an inside of the speaker device 100. The terminal member 36 has the function of electrically connecting the relay wiring lead out from the amplifier side and the voice oil.

In the speaker device 100 described above, an electric signal is inputted to the voice coil from the amplifier side via the terminal member 36 or the like, whereby a driving force occurs to the voice coil 34 in the magnetic gap 39, and vibrates the diaphragm 37 in the axial direction of the speaker device 100. In this manner, the speaker device 100 emits sound wave upward in FIG. 7A.

(Construction of Speaker Device 101)

FIG. 7B shows one example in which the damper 1a according to the second embodiment is applied to the speaker device. A speaker device 101 has the same construction as the speaker device 100, and therefore the explanation thereof will be omitted. Similarly to FIG. 3, illustration of the metal wires 11b of the damper 1a, which extend in the perpendicular direction to the paper surface, is omitted for convenience of illustration.

The damper 1a according to the second embodiment which has a large corrugated shape is especially applied to the speaker device 101, and therefore compliance can be made larger as compared with the speaker device 100. The other operation and effect in the speaker device 101 are the same as those in the speaker device 100 to which the damper 1 according to the first embodiment is applied, and therefore the explanation thereof will be omitted.

(Construction of Speaker Device 102)

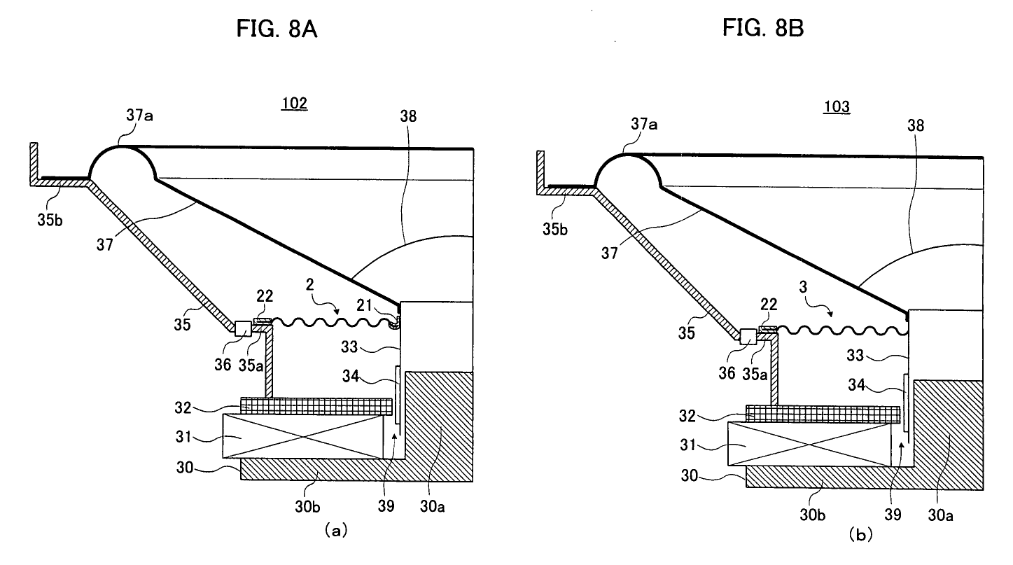

FIG. 8A shows one example in which the damper 2 according to the third embodiment is applied to the speaker device. A speaker device 102 has substantially the same construction as the speaker device 100, but the mounting state of the damper 2 to the voice coil bobbin 33 and the frame 35 is slightly different, and therefore this point will be explained. Similarly to FIG. 5, illustration of the metal wires 11b of the damper 2, which extend in the perpendicular direction to the paper surface, is omitted for convenience of illustration.

In the damper 2 according to the third embodiment, resin molding work is applied to its inner peripheral edge portion and outer peripheral edge portion, and the resin body 21 is formed at its inner peripheral edge portion and the resin body 22 is formed at the outer peripheral edge portion, respectively. Therefore, in the speaker device 102, the inner peripheral wall of the resin body 21 is fixed in the vicinity of the upper end of the outer peripheral wall of the voice coil bobbin 33, and the undersurface of the resin body 22 is fixed on the flange part 35a of the frame 35. By forming the resin bodies 21 and 22 at the damper 2 in this manner, it becomes possible to easily mount the damper 2 to the voice coil bobbin 33 and the frame 35 in the speaker device 102. The other operation and effect in the speaker device 102 are the same as those in the speaker device 100 to which the damper 1 according to the first embodiment is applied, and therefore the explanation thereof will be omitted.

(Construction of Speaker Device 103)

FIG. 8B shows one example in which the damper 3 according to the fourth embodiment is applied to the speaker device. A speaker device 103 has substantially the same construction as the speaker device 100, but the mounting state of the damper 3 to the frame 35 is slightly different, and therefore this point will be explained. Similarly to FIG. 6A, illustration of the metal wires 11b of the damper 3, which extend in the perpendicular direction to the paper surface, is omitted for convenience of illustration.

In the damper 3 according to the fourth embodiment, resin molding work is applied to its outer peripheral edge portion, and the resin body 22 is formed at this portion. Therefore, in the speaker device 103, the undersurface of the resin body 22 is fixed onto the flange part 35a of the frame 35. By forming the resin body 22 only at the outer peripheral edge portion of the damper 3 in accordance with the construction of the speaker device in this manner, it becomes possible to easily mount the damper 3 to the speaker device. The other operation and effect in the speaker device 103 are the same as those in the speaker device 100 to which the damper 1 according to the first embodiment is applied, and therefore the explanation thereof will be omitted.

(Construction of Speaker Device 104)

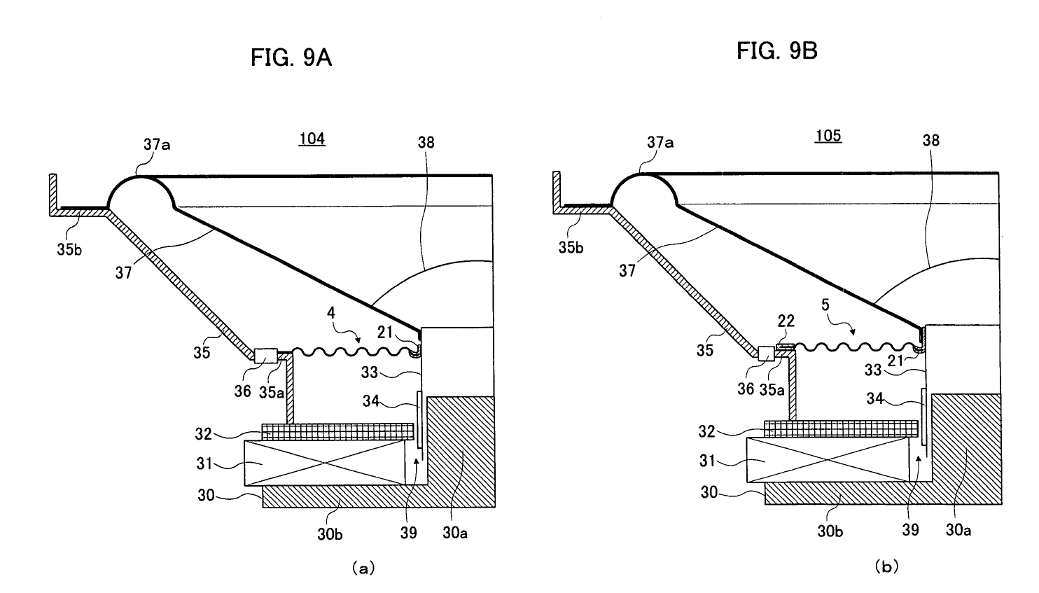

FIG. 9A shows one example in which the damper 4 according to the fifth embodiment is applied to the speaker device. A speaker device 104 has substantially the same construction as the speaker device 100, but the mounting state of the damper to the voice coil bobbin 33 is slightly different, and therefore this point will be explained. Similarly to FIG. 6B, illustration of the metal wires 11b of the damper 4, which extend in the perpendicular direction to the paper surface, is omitted for convenience of illustration.

In the damper 4 according to the fifth embodiment, resin molding work is applied to its inner peripheral edge portion, and the resin body 21 is formed at this portion. Therefore, in the speaker device 104, the inner peripheral wall of the resin body 21 is fixed to the outer peripheral wall of the voice coil bobbin 33. By forming the resin body 21 only at the inner peripheral edge portion of the damper 4 in accordance with the construction of the speaker device in this manner, it becomes possible to easily mount the damper 4 to the speaker device. The other operation and effect in the speaker device 104 are the same as those in the speaker device 100 to which the damper 1 according to the first embodiment is applied, and therefore the explanation thereof will be omitted.

(Construction of Speaker Device 105)

FIG. 9B shows one example in which the damper 5 according to the sixth embodiment is applied to the speaker device. A speaker device 105 has substantially the same construction as the speaker device 102, but the mounting state of the inner peripheral edge portion of the diaphragm 37 is slightly different, and therefore this point will be explained. Similarly to FIG. 6C, illustration of the metal wires 11b of the damper 5, which extend in the perpendicular direction to the paper surface, is omitted for convenience of illustration.

In the damper 5 according to the sixth embodiment, the length of the cylinder body 21a is formed to be longer with respect to the axial direction of the speaker device 105, and the inner peripheral edge portion of the diaphragm 37 is mounted to the outer peripheral wall of the cylinder body 21a. By forming the cylinder body 21a of the resin body 21 to be long in accordance with the construction of the speaker device in this manner, it becomes possible to easily mount the damper 5 and the like to the speaker device. The other operation and effect in the speaker device 105 are the same as those in the speaker device 100 to which the damper 1 according to the first embodiment is applied, and therefore the explanation thereof will be omitted.

[Manufacturing Method of Speaker Device]

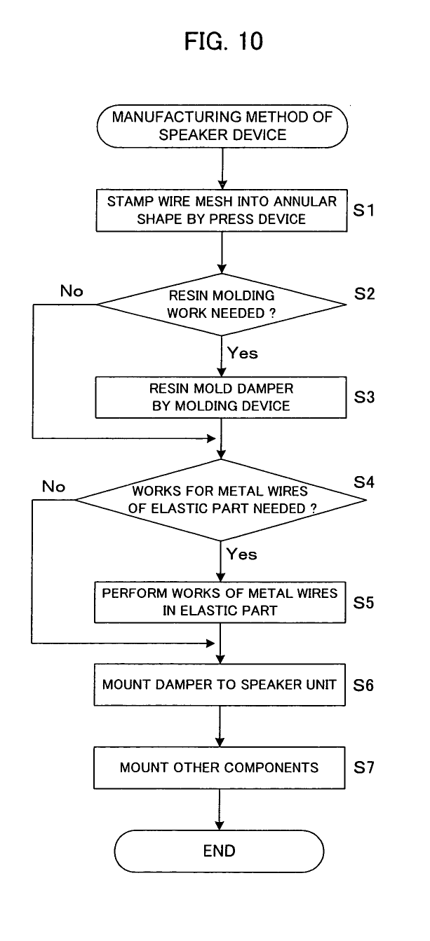

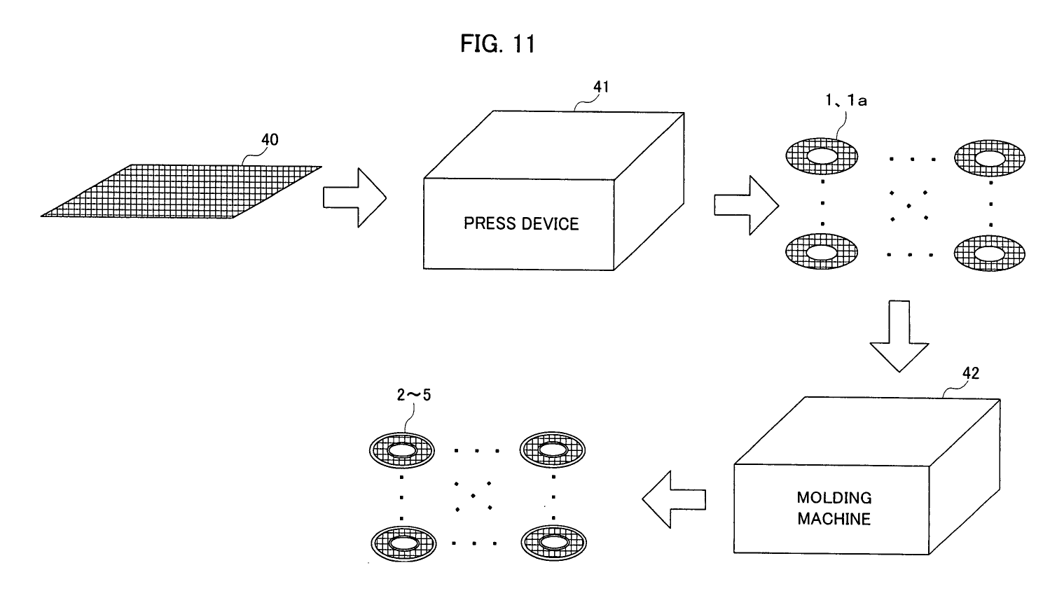

Next, referring to FIGS. 10 and 11, a manufacturing method of a speaker device having the damper of each of the embodiments of the present invention will be explained. FIG. 10 shows a flow chart of the manufacturing method of the speaker device. The selection in accordance with steps S2 and S4 shown in the flow chart is performed based on the previously set specification or design of the exact speaker device. FIG. 11 corresponds to the flow chart in FIG. 10 and schematically shows the manufacturing process of the damper of each of the embodiments of the present invention.

First, a wire mesh material 40 is manufactured by weaving a plurality of metal wires into the net shape, and the manufactured wire mesh material 40 is stamped out into an annular shape by a press device 41 (step S1). Thereby, a plurality of dampers 1 having the wire mesh structures are manufactured. In step S1, the damper 1a according to the second embodiment having a large recessed and projected shape, namely, the corrugated shape at the elastic part 11 can be manufactured by changing the mold in the press device 41. Namely, in this case, stamping of the annular damper 1a and formation of the recesses and projections for the elastic part 11 can be carried out in the same step.

In step S1, a plurality of dampers may be manufactured by using a wire mesh material in which the respective metal wires are coated with a resin. In this case, the damper 1 or 1a in which the respective metal wires of the elastic part 11 are coated with the resin is manufactured.

Next, when it is necessary to perform resin molding work (insert molding work) for the damper 1 or 1a (step S2; Yes), resin molding work is performed for the elastic part 11 of the damper 1 or 1a by the molding machine 42 (step S3). More specifically, the resin body 21 and/or the resin body 22 are/is formed on at least one of the inner peripheral edge portion and the outer peripheral edge portion of the elastic part 11. As a result, the dampers 2 to 5 having the resin body 21 and/or the resin body 22 are formed on at least one of the inner peripheral edge portion and the outer peripheral edge portion of the elastic part 11. Namely, if the resin body 21 and/or the resin body 22 are/is formed on at least one of the inner peripheral edge portion and the outer peripheral edge portion of the elastic part 11 of the damper 1a in step S3, the dampers 2 to 4 according to any of the third embodiment to the fifth embodiment are manufactured. If the cylinder body 21a of the resin body 21 is formed to be longer in step S3, the damper 5 according to the sixth embodiment is manufactured.

When various works for the elastic part 11 are needed (step S4; Yes), various works to the elastic part 11 are performed (step S5). More specifically, in the case of the damper in which the respective metal wires of the elastic part 11 are not coated with the resin, coating work is performed for the intersecting portions of the respective metal wires constructing the elastic part 11 or the entire surface of the elastic part 11, with an elastic material such as resin or rubber. As the coating method, various kinds of methods such as powder coating, resin spraying, static coating, brush coatings and impregnation with a resin or the like are cited. Meanwhile, when the respective metal wires of the elastic part 11 are already coated with a resin in step S1, connecting work for connecting the resins with which the respective metal wires are coated to each other by heat and ultrasonic waves is performed as necessary.

Next, any damper of the damper 1, the damper 1a or the damper 2 to damper 5 for which various kinds of works have been performed is mounted to the speaker unit (step S6), and the various kinds of other components are mounted to the speaker unit (step S7).

In this manner, any of the speaker devices 100 to 105 having the dampers according to the first embodiment to the sixth embodiment is manufactured.

[Modified Example]

In the above description, the dampers according to the first embodiment to the sixth embodiment are applied to the external magnet type speaker device. However, the application of the present invention is not limited to this, and it is also possible to apply the dampers according to the first to the sixth embodiments to the internal magnet type speaker device.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2004-144577 filed on May 14, 2004 including the specification, claims, drawings and summary is incorporated herein by reference in its entirety.

1. A damper for a speaker device, comprising:
an elastic part made by weaving a plurality of metal wires into a net shape.

2. The damper for a speaker device according to claim 1, wherein the elastic part is formed into a recessed and projected shape by being pressed by a press device.

3. The damper for a speaker device according to claim 2, wherein the elastic part is formed into an annular shape by being stamped out by the press device.

4. The damper for a speaker device according to claim 3, wherein a resin body is mounted, by a resin molding work, to an inner peripheral edge portion of the elastic part.

5. The damper for a speaker device according to claim 4, wherein the resin body has a cylinder body formed into a substantially cylindrical shape.

6. The damper for a speaker device according to claim 3, wherein a resin body is mounted, by a resin molding work, to an outer peripheral edge portion of the elastic part.

7. The damper for a speaker device according to claim 6, wherein the resin body is formed into a ring shape.

8. The damper for a speaker device according to claim 3, wherein a resin body is mounted, by a resin molding work, to an inner peripheral edge portion and an outer peripheral edge portion of the elastic part.

9. The damper for a speaker device according claim 8,
wherein the resin body mounted to the outer peripheral edge portion is formed into a ring shape; and
wherein the resin body mounted to the inner peripheral edge portion has a cylinder body formed into a substantially cylindrical shape.

10. The damper for a speaker device according to claim 1, wherein intersecting portions of the metal wires of the elastic part are coated with an elastic material.

11. The damper for a speaker device according to claim 10, wherein the intersecting portions of the metal wires coated with the elastic material are connected to each other.

12. The damper for a speaker device according to claim 1, wherein each of the plurality of metal wires is coated with an elastic material.

13. The damper for a speaker device according to claim 7, wherein intersecting portions of the metal wires coated with the elastic material are connected to each other.

14. The speaker device comprising the damper for a speaker device, the damper comprising:
an elastic part made by weaving a plurality of metal wires into a net shape.

15. The speaker device according to claim 14, wherein one end of a part of the metal wires constructing the elastic part of the damper is electrically connected to a voice coil, and the other end of the part of the metal wires is electrically connected to a relay wiring at a side of an amplifier via a terminal member.

16. A manufacturing method of a speaker device, comprising a damper manufacturing process comprising the steps of:
forming a wire mesh material by weaving a plurality of metal wires into a net shape; and
manufacturing a damper for a speaker device having an annular elastic part by stamping out the formed wire mesh material into an annular shape by a press device.

17. The manufacturing method of a speaker device according to claim 16, wherein the damper manufacturing process includes the step of forming the elastic part into a recessed and projected shape.

18. The manufacturing method of a speaker device according to claim 16, further comprising a resin molding process for forming a resin body to at least one of an inner peripheral edge portion and an outer peripheral edge portion of the elastic part of the damper for the speaker device manufactured in the damper manufacturing process.

19. The manufacturing method of a speaker device according to claim 16, further comprising a coating step for coating intersecting portions of the metal wires of the elastic part with an elastic material.

20. The manufacturing method of a speaker device according to claim 19, further comprising the step of connecting the intersecting portions of the metal wires coated with the elastic material to each other by applying heat or ultrasonic wave to the elastic part.

21. The manufacturing method of a speaker device according to claim 19, further comprising the step of electrically connecting one end side of a part of the metal wires coated with the elastic material and a voice coil, and electrically connecting the other end side of the metal wires to a relay wiring at a side of an amplifier via a terminal member.
